(19) United States
(12) Patent Application Publication
(10) Pub. No.: US 2015/0263650 A1
(43) Pub. Date: Sep. 17, 2015

(54) Predictive Landing Failsafe

(71) Applicant: CANRIG DRILLING TECHNOLOGY LTD., Houston, TX (US)

(72) Inventors: Beat KUTTEL, Spring, TX (US); Gary PACE, Cypress, TX (US); Kevin R. WILLIAMS, Cypress, TX (US); James GARAGHTY, Houston, TX (US); Tommy SCARBOROUGH, Houston, TX (US)

(21) Appl. No.: 14/656,930

(22) Filed: Mar. 13, 2015

Related U.S. Application Data
(60) Provisional application No. 61/952,452, filed on Mar. 13, 2014.

(51) Int. Cl. H02P 3/22; E21B 19/084; B66D 1/54; B66D 1/12

(52) U.S. Cl. CPC H02P 3/22; B66D 1/12; E21B 19/084; B66D 1/54

(57) ABSTRACT

A predictive landing failsafe system is adapted to slow or stop a permanent magnet AC motor in response to a selected condition, such as a power outage. In some embodiments, the predictive landing failsafe system may short two or more terminals of the AC motor in response to the selected condition. In some embodiments, one or more resistors may be coupled between the two or more terminals, the resistors lowering the short-circuit current and thus making a more smooth stop for the AC motor. In some embodiments, the AC motor may be used in a drawworks.

### CROSS-REFERENCE TO RELATED APPLICATIONS

This application is a non-provisional application which claims priority from U.S. provisional application No. 61/952,452, filed Mar. 13, 2014, which is incorporated by reference herein in its entirety.

### TECHNICAL FIELD/FIELD OF THE DISCLOSURE

The present disclosure relates generally to control systems for electric motors, and specifically to control systems for permanent magnet AC motor drawworks.

### BACKGROUND OF THE DISCLOSURE

While undergoing a drilling operation, a drilling rig utilizes a drawworks to raise and lower pieces of oilfield equipment. For example, the drawworks is used to raise and lower the interconnected lengths of drill pipe, casing, or the like, herein referred to as a tubular string, into and out of the wellbore. The tubular string, as well as additional connected equipment such as a top drive, travelling block, tubular elevator, etc., may be very heavy. The ability to precisely control movement of the drawworks may be critical to prevent damage to equipment as well as maintain a safe work environment for workers on the drilling rig.

Typical drawworks may be run using electric motors such as alternating current electric motors. AC electric motors rely on alternating currents passed through induction windings within the stator to cause rotation of the rotor. So-called three phase AC motors include three matched sets of windings positioned radially about the stator. By supplying sinusoidal AC power to each of the sets of windings such that each set receives an alternating current offset by 120 degrees, a continuously rotating electromagnetic field can be induced by the stator. The rotation of the electromagnetic field in turn causes rotation of the rotor.

In a permanent magnet AC motor, the rotor includes one or more permanent magnets which, in response to the rotating electromagnetic field, cause the rotor to rotate. Alternatively, if the rotor is rotated and no AC power is supplied to the windings of the stator, the movement of the magnetic field of the permanent magnets may induce voltage in the windings according to Lenz's Law.

### SUMMARY

The present disclosure provides for a predictive landing failsafe system. The predictive landing failsafe system may include an AC motor. The AC motor may be powered by one or more phases of AC power supplied through two or more terminals of the AC motor. The predictive landing failsafe system may also include a predictive landing failsafe controller. The predictive landing failsafe controller may include a contactor, the contactor having a normal operating position and a failsafe position, the contactor positioned to supply power to each phase of the AC motor when in the normal operating position and to electrically connect at least two terminals of the AC motor when in the failsafe position. The contactor may be positioned to be automatically transitioned from the normal operating position to the failsafe position in response to a selected condition.

The present disclosure also provides for a hoist. The hoist may include a drum. The hoist may also include an AC motor. The AC motor may be powered by one or more phases of AC power supplied through two or more terminals of the AC motor. The AC motor may be positioned to rotate a shaft, the shaft coupled to the drum. The hoist may also include a predictive landing failsafe controller. The predictive landing failsafe controller may include a contactor, the contactor having a normal operating position and a failsafe position, the contactor positioned to electrically couple a power source to each phase of the AC motor when in the normal operating position and to electrically connect at least two terminals of the AC motor when in the failsafe position. The contactor may be positioned to be automatically transitioned from the normal operating position to the failsafe position in response to a selected condition.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of an oil rig electrical system consistent with embodiments of the present disclosure.

FIGS. 2A-2D depict predictive landing failsafe systems consistent with embodiments of the present disclosure coupled to different winding configurations for an electric motor.

FIG. 3 depicts a drawworks utilizing a predictive landing failsafe system consistent with embodiments of the present disclosure.

FIG. 4 depicts a detailed view of the drawworks of FIG. 3.

FIG. 5 depicts a predictive landing failsafe system consistent with embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

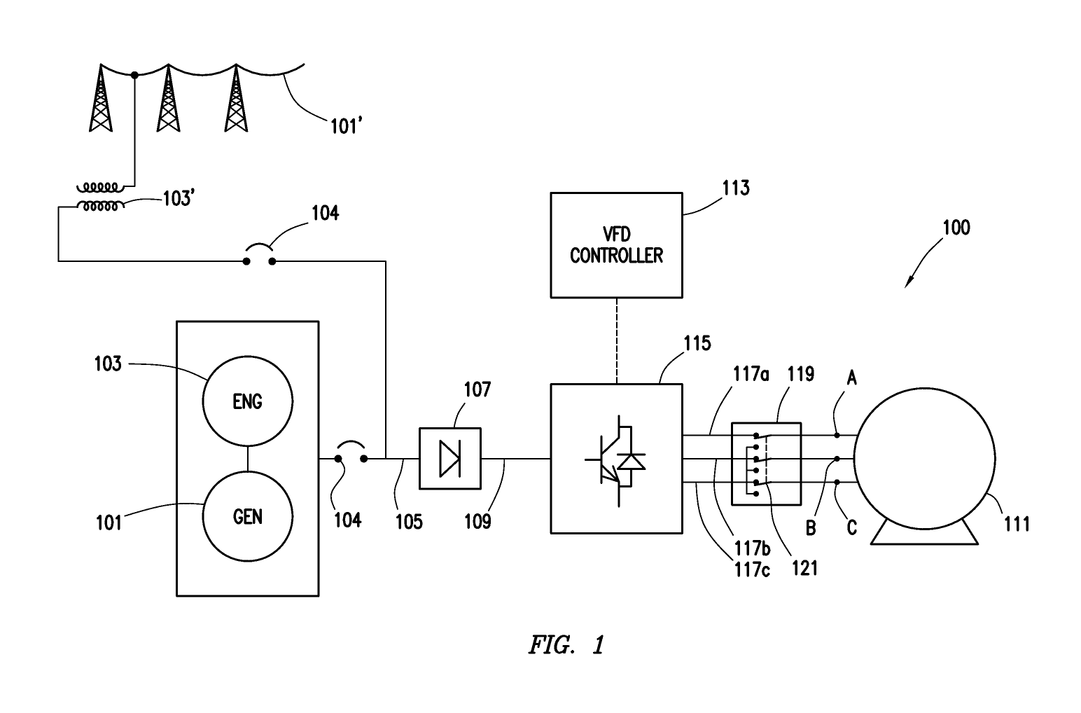

FIG. 1 depicts a block diagram of a partial oil rig electrical system 100 consistent with embodiments of the present disclosure. In some embodiments, power may be supplied to oil rig electrical system 100 by generator 101. Generator 101 may be driven by engine 103. In some embodiments, engine 103 may be driven by natural gas. In some embodiments, power may be supplied to oil rig electrical system 100 from line power 101′. As understood in the art, line power 101′ may be sourced from, for example and without limitation, a local utility power grid. In some embodiments, line power 101′ may be transformed from, for example, high voltage to a lower voltage by transformer 103′. In some embodiments, line power 101′ and generator 101 may be coupled to the rest of oil rig electrical system 100 through one or more circuit breakers 104 as understood in the art. Generator 101 and line power 101′ may supply power through supply line 105. In some embodiments, the power supplied may be rectified by one or more rectifiers 107. Here, rectifiers 107 are depicted as a single diode, but one having ordinary skill in the art with the benefit of this disclosure will understand that any suitable rectifier arrangement may be used, including without limitation, half bridge, full bridge, single or multiphase, etc. The output electricity, coupled to DC power bus 109, may then be used to power other electrical equipment.

In some embodiments of the present disclosure, the electrical equipment may include AC motor 111. AC motor 111 may, in some embodiments, be a permanent magnet AC motor, positioned to rotate in response to AC power supplied to AC motor 111. In some embodiments, AC power may be supplied using VFD controller 113 to control inverter 115. Inverter 115 may be positioned to provide pulse width modulated AC current to AC motor 111 as controlled by VFD controller 113. One having ordinary skill in the art with the benefit of this disclosure will understand that rectifier 107, VFD controller 113, and inverter 115 need not be used to power AC motor 111. Instead, AC power may be supplied directly from generator 101. Additionally, one having ordinary skill in the art with the benefit of this disclosure will understand that AC power may be supplied to oil rig electrical system 100 by, for example, a municipal power supply.

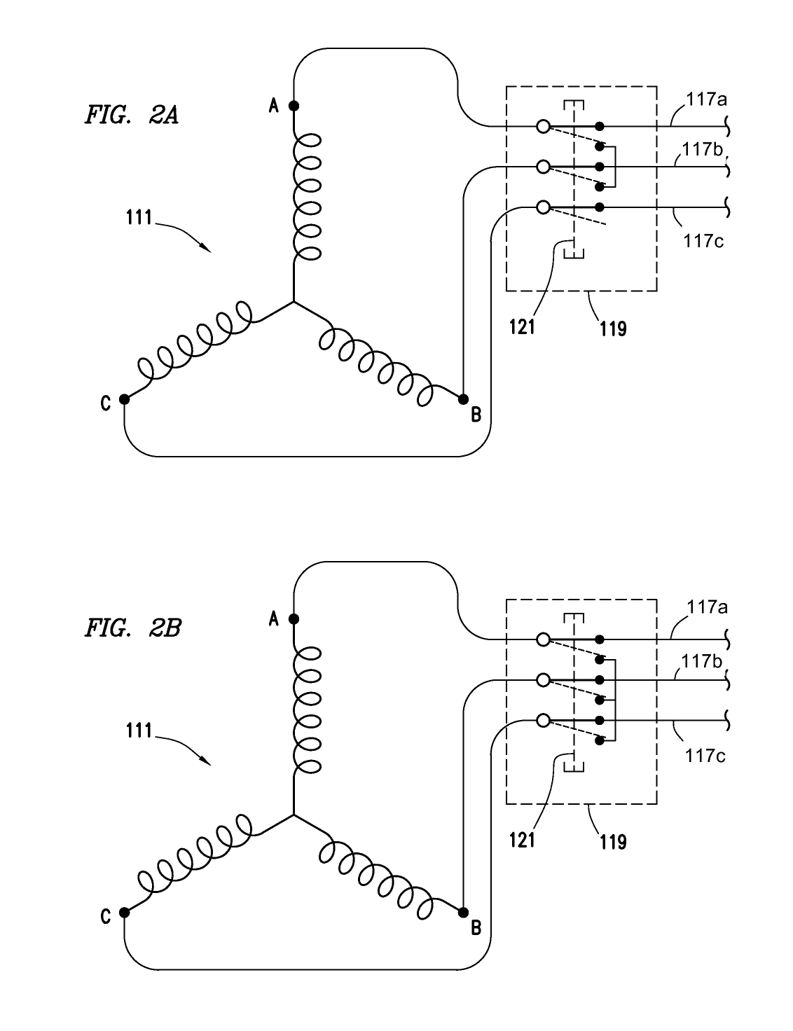

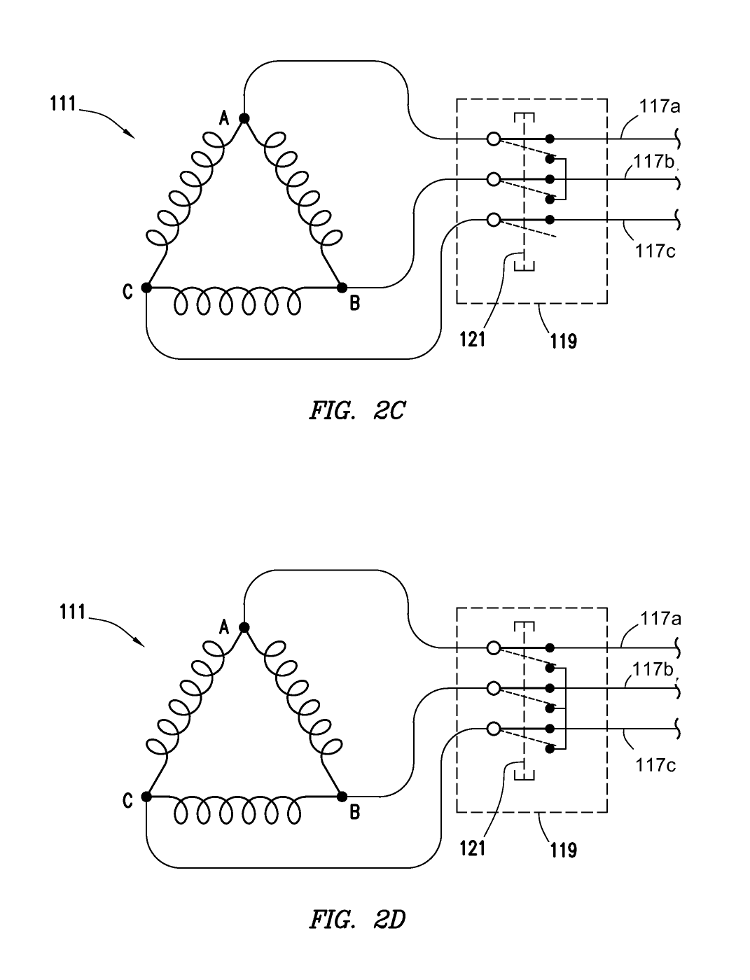

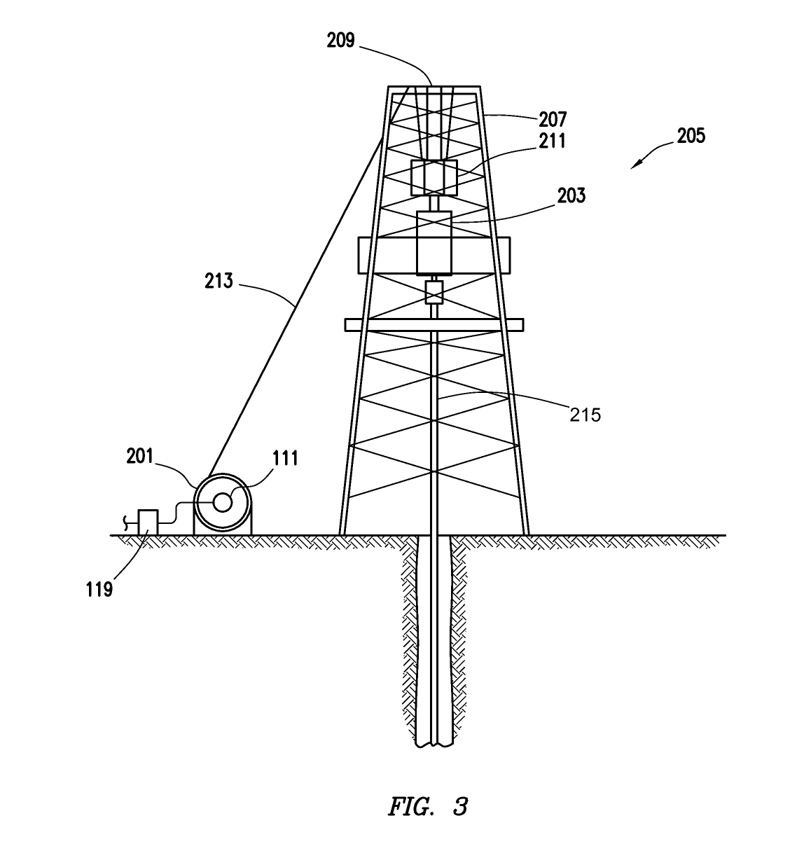

In some embodiments, AC motor 111 may be a single or multi-phase AC motor. As understood in the art, the number of phases of an AC motor corresponds to the number of windings or winding phase groups of AC motor. In a single phase AC motor, one phase of AC power is supplied to the windings of the AC motor through a single conductor, with a neutral conductor electrically coupled to the opposite ends of the windings. In a three-phase AC motor, such as depicted in FIG. 1, three phases of AC power are supplied to AC motor 111, each through a separate conductor 117a-c coupled to a terminal of AC motor 111. In a three-phase AC motor, the windings are grouped into three winding phase groups. As depicted in FIGS. 2A-2D, terminals A, B, and C may be connected to the winding groups in a Wye configuration (FIGS. 2A, 2B) or a delta configuration (FIGS. 2C, 2D). In each configuration, each phase of the AC power supplied to the AC motor is supplied to a corresponding terminal A, B, or C, with a phase offset 120 degrees to the other two phases.

As depicted in FIG. 1, oil rig electrical system 100 may further include a predictive landing failsafe system 119. Predictive landing failsafe system 119 may, as depicted in FIG. 1, include contactor 121. Contactor 121 may be positioned to selectively couple or decouple each of conductors 117a-c with terminals A, B, C of AC motor 111. When coupled, conductors 117a-c are capable of powering AC motor 111 through terminals A, B, C thereof. When disconnected, AC motor 111 is disconnected from the AC power oil rig electrical system 100.

In some embodiments, when contactor 121 decouples conductors 117a-c from AC motor 111, contactor 121 is positioned to instead short between at least two terminals A, B, C of AC motor 111. If AC power is not supplied to AC motor 111, as the permanent magnets on the rotor of AC motor 111 rotate, the electromagnetic flux on each winding group varies and, according to Lenz's Law, electricity is induced into the windings. This generated electricity is known as back EMF. When at least two terminals A, B, C of AC motor 111 are shorted, the back EMF of each winding group creates a short circuit current. The magnetic field of the permanent magnets of the rotor of AC motor 111 are opposed by the induced electromagnetic field, and a resultant braking or stopping force is imparted on the rotor. This braking or stopping force is known as dynamic braking

As depicted in FIGS. 2A-2D, contactor 121 may switch between a normal operating mode, in which each terminal A, B, C is coupled to a conductor 117a-c respectively, and a failsafe mode, in which each terminal A, B, C is disconnected from the respective conductor 117a-c and at least two of which are connected directly together (dashed lines). As depicted in FIGS. 2A, 2C, terminals A and B are shorted together. As depicted in FIGS. 2B, 2D, all three terminals A, B, C are shorted together. In the failsafe configurations, because two or more of the terminals are shorted together, dynamic braking occurs, thus slowing or stopping AC motor 111. In some embodiments, the dynamic braking force may be sufficient to completely stop the movement of AC motor 111.

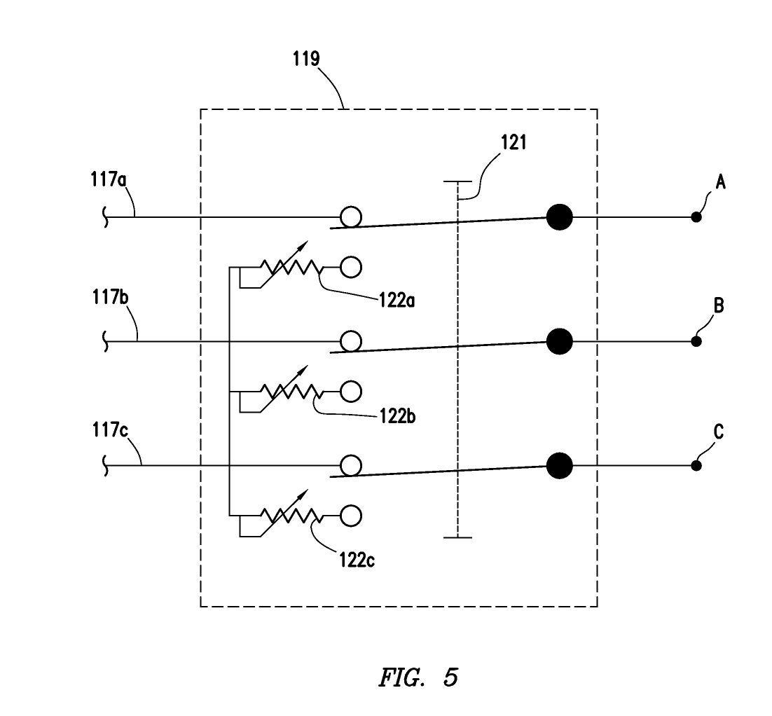

In some embodiments, the short circuit current previously described may, for example, cause an abrupt and immediate stoppage of the rotor of AC motor 111. In some embodiments, as depicted in FIG. 5, one or more resistors 122a-c may be included in predictive landing failsafe system 119. Resistors 122ac may, for example, be adapted to lower the short circuit current when in the failsafe configuration. By lowering the short circuit current, the rate of deceleration of the rotor of AC motor 111 may be lowered, thus allowing the rotor to come to a more smooth stop. In some embodiments, resistors 122ac may be variable resistors as depicted. By varying the resistance of each of the resistors 122ac, the rate of deceleration may be controlled. In some embodiments, the selected resistance value for resistors 122ac may be small so that sufficient short circuit current remains to completely stop the rotor of AC motor 111 despite any external load imparted on the rotor. In other embodiments, the selected resistance value for resistors 122ac may be high enough that the rotor of AC motor 111 is slowed but may be capable of turning a desired speed under external load. In some embodiments, the selected resistance value for resistors 122ac may be optimized based on, for example, the intended application of AC motor 111 and any expected load during normal operation of AC motor 111.

In some embodiments of the present disclosure, predictive landing failsafe system 119 may be coupled to oil rig electrical system 100 such that when power is being supplied, contactor 121 remains in the normal operating mode. In response to a certain condition, predictive landing failsafe system 119 may be positioned to cause contactor 121 to trip into the failsafe position, thus halting the rotation of AC motor 111 immediately. In some embodiments, the certain condition may be a power outage or blackout on oil rig electrical system 100. For example, in some embodiments, contactor 121 may be held in the normal operating position by a spring-opposed electromagnet (not shown) powered by oil rig electrical system 100. If a blackout occurs, the electromagnetic attraction between the electromagnet and contactor 121 may cease, allowing the spring to move the contactor into the failsafe position. In some embodiments, the condition may be a manual override triggered by an operator, such as in an “E-stop” condition.

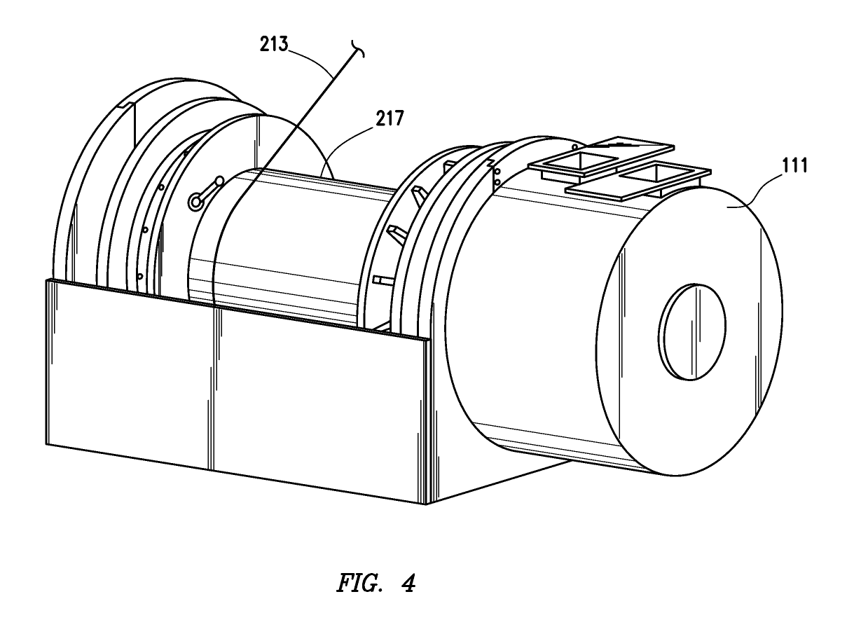

In some embodiments of the present disclosure, AC motor 111 may be used as part of a piece of oilfield equipment. With reference to FIG. 3, AC motor 111 may be used to drive, without limitation, drawworks 201, top drive 203, or a rotary table (not shown). For the purposes of this disclosure and to clarify the operation of the present disclosure, an embodiment in which AC motor 111 is used as part of drawworks 201 will be described. Additionally, although described herein as a drawworks, one having ordinary skill in the art with the benefit of this disclosure will understand that drawworks 201 may be any hoist apparatus and is not limited to lifting or supporting the described equipment.

FIG. 3 depicts oil rig 205. Oil rig 205 may include derrick 207. Derrick 207 may be positioned to support crown block 209. Crown block 209 may be coupled to travelling block 211 by wireline 213. Wireline 213 may be coupled to drawworks 201. As understood in the art, crown block 209 and travelling block 211 may include one or more pulleys positioned to allow wireline 213 to lift or lower travelling block 211 relative to crown block 209 as wireline 213 is paid in or out by drawworks 201. In some embodiments, travelling block 211 may be coupled to top drive 203. Top drive 203 may be used to support a string of interconnected tubular members such as tubular string 215 as depicted.

As depicted in FIG. 4, drawworks 201 may include AC motor 111. AC motor 111 may be coupled by, for example a shaft (not shown), to drum 217. Wire line 213 may wrap around drum 217 such that as drum 217 is rotated by AC motor 111, wire line 213 extends or retracts depending on the direction of rotation of drum 217.

As an example, a lowering operation for tubular string 215 will be described. Once tubular string 215 is properly coupled to travelling block 211, wireline 213 may be extended by drawworks 201. As wireline 213 extends, travelling block 211 lowers, causing tubular string 215 and any other equipment such as top drive 203 to be lowered. During normal operation, predictive landing failsafe system 119 may remain in the normal operating mode. In the event of a power outage or other condition, predictive landing failsafe system 119 may trip into the failsafe mode, causing rotation of AC motor 111, and thus rotation of drawworks 201 to slow or stop. As drawworks 201 slows or stops, wireline 213′s extension is slowed or stopped, causing the descent of tubular string 215 to likewise slow or stop. By automatically triggering this slowing or stoppage of tubular string 215 without the need for additional power or operator input, damage to, for example, top drive 203, travelling block 211, or tubular string 215 and any associated components may be prevented. Additionally, damage to a wellbore or to the seabed for offshore drilling operations may likewise be prevented. Furthermore, safety of rig personnel may be increased and injuries may be prevented.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A predictive landing failsafe system comprising:
an AC motor, the AC motor powered by one or more phases of AC power supplied through two or more terminals of the AC motor; and
a predictive landing failsafe controller, the predictive landing failsafe controller including a contactor, the contactor having a normal operating position and a failsafe position, the contactor positioned to supply power to each phase of the AC motor when in the normal operating position and to electrically connect at least two terminals of the AC motor when in the failsafe position, the contactor positioned to be automatically transitioned from the normal operating position to the failsafe position in response to a selected condition.

2. The predictive landing failsafe system of claim 1, wherein the AC motor is a permanent magnet AC motor.

3. The predictive landing failsafe system of claim 1, wherein the predictive landing failsafe controller further comprises a spring positioned to bias the contactor into the failsafe position and an electromagnet positioned to retain the contactor in the normal operating position against the pressure of the spring while power is supplied to the electromagnet.

4. The predictive landing failsafe system of claim 3, wherein the AC power is supplied by a power source, and the power source is also used to energize the electromagnet, so that a failure of the power source de-energizes the electromagnet causing the contactor to move into the failsafe position.

5. The predictive landing failsafe system of claim 3, wherein the electromagnet is selectively de-energizable by the interaction of an operator.

6. The predictive landing failsafe system of claim 3, wherein the permanent magnet AC motor is a single phase AC motor having a live terminal and a neutral terminal through which single phase AC power is supplied, and the contactor, when in the failsafe position, electrically couples the live terminal with the neutral terminal.

7. The predictive landing failsafe system of claim 3, wherein the permanent magnet AC motor is a multi-phase AC motor having a terminal corresponding to each phase of AC power supplied to the permanent magnet motor, and the contactor, when in the failsafe position, electrically couples at least two terminals of the permanent magnet AC motor.

8. The predictive landing failsafe system of claim 7, wherein the permanent magnet AC motor is a three phase AC motor, the permanent magnet AC motor having three terminals, and the contactor, when in the failsafe position, electrically couples two of the three terminals.

9. The predictive landing failsafe system of claim 7, wherein the permanent magnet AC motor is a three phase AC motor, the permanent magnet AC motor having three terminals, and the contactor, when in the failsafe position, electrically couples the three terminals.

10. The predictive landing failsafe system of claim 3, further comprising at least one resistor positioned between the at least two terminals of the permanent magnet motor.

11. The predictive landing failsafe system of claim 10, wherein the resistor is a variable resistor.

12. A hoist comprising:
a drum;
an AC motor, the AC motor powered by one or more phases of AC power supplied through two or more terminals of the AC motor, the AC motor positioned to rotate a shaft, the shaft coupled to the drum; and
a predictive landing failsafe controller, the predictive landing failsafe controller including a contactor, the contactor having a normal operating position and a failsafe position, the contactor positioned to electrically couple a power source to each phase of the AC motor when in the normal operating position and to electrically connect at least two terminals of the AC motor when in the failsafe position, the contactor positioned to be automatically transitioned from the normal operating position to the failsafe position in response to a selected condition.

13. The hoist of claim 12, where the hoist is a drawworks.

14. The hoist of claim 12, wherein the predictive landing failsafe controller further comprises a spring positioned to bias the contactor into the failsafe position and an electromagnet positioned to retain the contactor in the normal operating position against the pressure of the spring while power is supplied to the electromagnet.

15. The hoist of claim 14, wherein the power source is also used to energize the electromagnet, so that a failure of the power source de-energizes the electromagnet causing the contactor to move into the failsafe position.

16. The hoist of claim 14, wherein the electromagnet is selectively de-energizable by the interaction of an operator.

17. The hoist of claim 12, wherein the AC power source comprises a VFD, the VFD positioned to supply pulse width modulated AC power to each phase of the AC motor.

18. The hoist of claim 12, wherein the AC motor is a permanent magnet AC motor.

19. The hoist of claim 18, wherein the permanent magnet AC motor is a single phase AC motor having a live terminal and a neutral terminal through which single phase AC power is supplied, and the contactor, when in the failsafe position, electrically couples the live terminal with the neutral terminal.

20. The hoist of claim 18, wherein the permanent magnet AC motor is a multi-phase AC motor having a terminal corresponding to each phase of AC power supplied to the permanent magnet AC motor, and the contactor, when in the failsafe position, electrically couples at least two terminals of the permanent magnet AC motor.

21. The hoist of claim 20, wherein the permanent magnet AC motor is a three phase AC motor, the permanent magnet AC motor having three terminals, and the contactor, when in the failsafe position, electrically couples two of the three terminals.

22. The hoist of claim 20, wherein the permanent magnet AC motor is a three phase AC motor, the permanent magnet AC motor having three terminals, and the contactor, when in the failsafe position, electrically couples the three terminals.

23. The hoist of claim 18, further comprising at least one resistor positioned between the at least two terminals of the permanent magnet motor.

24. The hoist of claim 23, wherein the resistor is a variable resistor.

25. The hoist of claim 12, where the hoisting mechanism is a winch.

26. The hoist of claim 25, where the hoisting apparatus is an elevator winch.
